(19) United States
(12) Patent Application Publication
(10) Pub. No.: US 2003/0151868 A1
(43) Pub. Date: Aug. 14, 2003

(54) Over-voltage secondary battery protector and system using same

(76) Inventors: Masao Inae, Yokohama-shi (JP); Kohya Baba, Gotenba-shi (JP)

Correspondence Address: Russell E. Baumann, Texas Instruments Incorporated, 34 Forest St., MS 20-21, Attleboro, MA, 02703, US

(21) Appl. No.: 10/361,388

(22) Filed: Feb. 10, 2003

(30) Foreign Application Priority Data
Feb. 12, 2002 (JP) 2002-033478

(51) Int. Cl. H02H 3/14

(52) U.S. Cl. 361/88

(57) ABSTRACT

An over-voltage protection device (51) for a secondary battery is disclosed which includes an outer casing (52) with plastic cover (53), terminals (56, 57, 58) and a piezoelectric actuator (54). Piezoelectric actuator (54) has first and second electrodes which are electrically connected to terminals (56, 57) respectively. Terminal (58) has a stationary electrical contact (60) mounted therein. The piezoelectric actuator (54) is cantilever mounted within casing (52) with a movable contact (61) mounted on its distal end that is positioned to be in engagement with stationary contact (60). When an over-voltage is applied between terminals (56, 57), it causes a displacement of the distal end of piezoelectric actuator (54) and correspondingly of the disengagement of movable contact (61) from stationary contact (60).

### FIELD OF THE INVENTION

This invention relates to an over-voltage protection device and a battery protection system using same for the prevention of over-charging of secondary batteries of particularly the non-aqueous type.

### BACKGROUND OF THE INVENTION

The secondary batteries of a charging system typically are of two types: the first using an electrolyte that is combustible which is a non-aqueous system, and the second using an electrolyte that is not combustible, which is an aqueous system. The secondary battery of a non-aqueous system is being rapidly used as the battery of choice for small-sized and light-weight portable telephones or notebook personal computers because of its high energy density and high voltage generation.

A typical non-aqueous secondary battery is a lithium ion battery which uses lithium that is chemically unstable and a combustible electrolyte, both of which are sealed in an iron or aluminum can or a laminated case made of a high strength polymer resin. Different from the typical aqueous nickel cadmium secondary battery, the lithium ion battery has its lithium ion precipitated as a lithium metal at the time of an over-charge condition from over-voltage. If the chemical reaction progresses from such a state, the battery temperature rises and the metallic lithium undergoes a chemical reaction. This causes a violent rise in heat and/or the decomposition of the electrolyte, thereby producing gas and elevating the pressure inside the casing, sometimes leading to a rupture of the metal can and other serious accidents.

On the other hand, if the battery becomes discharged, such that a metallic ion as copper, etc., dissolves and precipitates from the electrode inside the battery, inner short-circuiting can result between the positive and negative poles thereby lowering the efficiency of the battery. When a battery which has undergone such an inner short-circuiting is recharged, a large electric current flows, thereby generating heat, with a possible result similar to the case of an over-charge as described above. Accordingly, it is important to use a protection device/system with such non-aqueous secondary batteries.

FIG. 17 shows a cross section showing the construction of an angular type lithium ion battery. A battery metal casing 201 is filled with an electrolyte 202 and a positive electrode plate 203 and a negative electrode plate 204 are separated from each other by means of a separator 205. The positive electrode plate 203 is connected to a positive pole 207 of the battery through a connective tab 206 and the negative pole electrode 204 is connected to casing 201 which serves as a negative pole through a connective tab 208. A safety valve 209 is provided in the casing 201, with safety valve 209 and separator 205 serving as a safety mechanism for the battery.

The separator 205 is made of a polymer film, with fine pores being formed on the film so that the ions may pass freely. When the internal temperature becomes high, the film starts to dissolve so as to close off the fine pores, thereby shutting off the flow of ions (the flow of electric current). The safety valve 209 is for the purpose of discharging the gas before the high pressure gas inside the casing destroys the casing 201; it is made of a metal plate which is thinner than that of the casing 201.

FIG. 18 shows an example of the angular type lithium ion battery device for a device such as a portable telephone. A lithium ion battery 211 is mounted on a semiconductor protective circuit substrate 212 which is normally accommodated inside a plastic case. The positive electrode terminal is connected to the protective circuit substrate through a connective tab 213 and the battery casing which serves as s negative electrode terminal is connected to the protective circuit substrate via a tap 215 and a positive temperature coefficient (PTC) element 214.

PTC element 214 is constructed so that it becomes a high value resistor and restricts the electric current flow when the temperature rises above a certain level. In place of the PTC element, it is possible to use a temperature fuse or a bimetal breaker so as to offer protection against an abnormal elevated temperature.

FIG. 19 is a block diagram showing the construction of protective circuit substrate 212. A charging current 225 flows from the charging device 224 through the terminals 222 and 223 of a lithium ion battery. At the time of a discharge, on the other hand, a discharge current 227 flows through the terminals 222 and 223 from the load 226. A semiconductor protective circuit 228 is connected between the terminals 222 and 223 and this protective circuit 228 monitors the voltage and the current, by controlling the charging current 225 by a switch 229 and the discharge current 227 by a switch 230, thereby preventing any over-voltage being impressed to the lithium ion battery or allowing the lithium ion battery from going below the lowest battery voltage. Numeral 231 indicates a thermal responsive element such as a PTC element, temperature fuse or a bimetal breaker which carries out secondary protection of the protective circuit 228.

FIG. 20 shows the details of protective circuit 218. The semiconductor protective circuit 228 includes comparators 241 and 242. The voltage that has been resistance-divided is inputted into each of the comparators and a standard electrical potential for the detection of an excess voltage is inputted into one and the lowest voltage is inputted to the other comparator. For example, comparator 241 detects the existence of an excessively large voltage between the terminals and sets off the MOS transistor 243. Comparator 242 detects the fact that the lowest voltage has been impressed and sets off the MOS transistor 244. A current detector 245 detects a large current discharged and sets off the MOS transistor 244. In the case where the semiconductor protective circuit 228 has not worked properly, a thermal responsive protective element 231 functions as a secondary protector and detects the temperature elevation in the battery, thereby either restricting or shutting off the circuit current.

The above primary, secondary and tertiary protections are offered against the possible troubles caused by an abnormal functioning of the battery. If, for example, an excessively large voltage is impressed due to an abnormal operation at the time of a battery charging, it is the semiconductor protective circuit 228 that acts at first. In the case where the semiconductor circuit 228 does not function properly as a primary protector and consequently the non-reversible chemical reaction of the battery progresses and heat is generated, then thermal responsive protective element 231 (PTC, temperature fuse, or bimetal breaker) as a secondary protective device will cause the circuit current to be either restricted or shut off. If the battery trouble further progresses, the separator 205 and/or the safety valve 209 that has been provided in the battery itself provides a third protective device, with a result that the electrolyte is shut off or the gas is discharged.

However, the protection device and protective system for the conventional secondary charging device of the non-aqueous system as described above has shown at times to have the following problems.

If lightning strikes during the charging to a secondary battery of a non-aqueous system or if the charging device is misused, thereby developing an abnormal situation in the charge voltage, etc., it is the semiconductor protective circuit whose duty it is to watch the charge or discharge voltage and render the initial action. In view of the fact that this circuit is constructed using semiconductor elements, it is very likely such elements will be destroyed by a surge voltage or an electrostatic discharge. Further, in the case where a strong electromagnetic wave has been received, there is a possibility that the wiring pattern induces an erroneous action by serving as an antenna, thereby making it impossible for the semiconductor protective current to perform a normal protective action.

Moreover, many circuit elements are mounted on the substrate by soldering. If there are problems in reliability of the solder, the energy from the electric source for charging can be continuously supplied to the battery, with a result that the battery is over-charged, thereby causing excessive heating or ruptures, etc.

If a fluid leak takes place from the case of the battery of the non-aqueous system, the electronic circuit that has been contacted by the electrolyte can malfunction causing a large current to flow and heat to be generated. In such-an event, there is a danger that the combustible electrolyte will become heated and start generating smoke or even catch fire. Also, when the battery has reached a-point below the pre-set lowest voltage level, if the battery is left in such a condition for a long period of time, the protective circuit itself consumes the electric current in addition to the self-discharge of the battery, with a consequence that the lowering of the voltage is accelerated.

Still further, the two MOS transistors 243 and 244 are connected in series with the inner resistance of the battery element, with a result that the resistance of the circuit is relatively high. This will result in a greater degree of voltage drop in the case of a portable telephone in which the pulse load current is large, thereby shortening the charge life of the battery. It is possible to use a small-size electromagnetic relay in the place of the MOS transistor as a current shut-off element; however, this option is not acceptable where small size is important as in a portable telephone.

Also, the protective elements of prior art systems using thermal responsive devices such as the PTC, bimetal circuit breakers or temperature fuses, etc., only provide secondary protection action which in certain instances is too slow to completely protect the battery.

### SUMMARY OF THE INVENTION

Accordingly, an object of the present invention is the provision of an over-voltage protective device which has improved construction and which overcomes the limitations and problems of the above-noted conventional non-aqueous system secondary battery protection devices and systems using them. Another object of the present invention is an over-voltage protection device which has a high level of reliability, is small in size and is economical to produce. Still another object of this invention is an over-voltage protection device having a protective function against over-voltage and over-heating or excessive current for secondary batteries. Yet still another object of this invention is an over-charge protective device employing a piezoelectric actuator of the bimorph type which can be activated at a low voltage.

Briefly, an over-voltage protection device for protecting a secondary battery according to a first embodiment of the invention comprises a casing, at least first, second and third terminals, and a piezoelectric actuator having first and second electrodes, the piezoelectric actuator being supported in the casing like a cantilever, with a movable contact being provided at its tip positioned to be able to make contact with a stationary contact-mounted on said third terminal, the first and second electrodes of the piezoelectric actuator being electrically connected to the first and second terminals respectively, whereby when a voltage is impressed between the first and second terminals, the tip of the piezoelectric actuator is capable of being displaced bringing the movable contact into or out of engagement with the stationary contact.

The piezoelectric actuator preferably contains piezoelectric ceramic elements which have been laminated in multi-layers and the movable contact at the tip is displaced by the reverse piezoelectric effect at the time when the voltage has been impressed between the first and second terminals. By laminating the piezoelectric ceramic elements in multi-layers, it becomes possible to produce a large displacement force even when the voltage impressed is small.

Moreover, the piezoelectric actuator may contain a metal plate which extends in the longitudinal direction at its center, with the metal plate working as the first electrode of the piezoelectric actuator with a plurality of piezoelectric elements being laminated on both sides of the metal plate. By providing a metal plate at the center, it becomes possible to improve the mechanical strength so that the movable contact of the piezoelectric actuator may contact the stationary contact with a firm contacting pressure. Additionally, the metal plate makes it easier to adhere the thin film piezoelectric elements on both sides of the metal plate.

The casing for the over-voltage protective device preferably offers a substantially closed space inside and has a triple-terminal structure wherein the firsthand second terminals protrude from a first end in the longitudinal direction of the casing and the third terminal protrudes from a second end that opposes the first end of said casing, thereby making for a small size miniature device.

The over-voltage protective device according to another embodiment comprises a casing, at least first, second and third terminals, said third terminal having a fixed contact mounted thereon, a piezoelectric actuator having first and second electrodes and a movable arm, made from an electroconductive material, having a movable contact mounted thereon being positioned to be able to make and break contact with said fixed contact in response to movement by said piezoelectric actuator, said piezoelectric actuator being cantilever mounted in the casing and first and second electrodes of the piezoelectric actuator are electrically connected to the first and second terminals respectively, whereby, when a voltage is impressed to the first and second terminals, the piezoelectric actuator is capable of movement to thereby cause said movable arm to move so that the movable contact will move out of or into engagement with the stationary contact.

Preferably, the movable arm engages in snap action movement as it is contacted by the piezoelectric actuator.

The over-voltage protection device according to a third embodiment of this invention is an over-voltage protection device that protects the secondary battery from over-voltage but includes a bimetal element instead of the elastic movable arm to work with said piezoelectric actuator thereby also providing over-current/temperature protection.

In yet another embodiment of the present invention, the protection system includes a snap action drive circuit.

In accordance with this invention, it becomes possible to drastically reduce the number of parts required by using a simplified construction as compared with the conventional semiconductor protective circuit, thereby making it possible to reduce the cost.

When the prior art of the semiconductor integrated circuit was employed, there was a reliability problem due to inadequate soldering, reliability of the MOS transistor, etc. In the case of the over-voltage protection device of the present invention using the piezoelectric actuator, however, there are no problems stemming from the above items, with a resultant elimination of the reliability problem.

### BRIEF DESCRIPTION OF THE DRAWINGS

The accompanying drawings which are incorporated and constitute a part of the specification, illustrate preferred embodiments of the invention, and together with the description, serve to explain the objects, advantages and principals of the invention. In the drawings:

FIG. 1 shows a cross sectional view of a piezoelectric ceramic actuator;

FIG. 2 shows the voltage vrs displacement characteristics of the piezoelectric actuator;

FIG. 3(a) shows the deflection property of the piezoelectric actuator and FIG. 3(b) shows the relationship between displacement and force for the actuator;

FIG. 4 shows various views of a piezoelectric actuator of a six-layer structure where three layers of piezoelectric elements have been laminated on each side of a shim plate;

FIG. 5(a) shows a side cross sectional view of an over-voltage protection device according to a first embodiment of this invention and FIG. 5(b) shows a top view of the device of FIG. 5(a) where the cover has been removed;

FIG. 6(a) is a top view of a piezoelectric actuator and FIG. 6(b) is a side view;

FIG. 7 shows a protection circuit using an over-voltage protection device;

FIG. 8 shows the circuit shut-off action characteristics of an over-voltage protection device using a piezoelectric actuator;

FIG. 9 shows a view of an over-voltage protection device mounted with a secondary battery;

FIG. 10 shows a top cross sectional view with the cover removed of an overload voltage protection device according to the second embodiment of this invention;

FIG. 11 shows a side cross sectional view of an overload voltage protection device according to the second embodiment of this invention;

FIG. 12 shows a perspective view of a spring member used in the overload voltage protection device of FIGS. 10 and 11;

FIGS. 13(a)-13(c) show diagrammatical models for the spring member of FIG. 12;

FIG. 14 shows a graph showing the relation between displacement and stress at time of snap action of the spring member of FIG. 12;

FIG. 15(a) shows a side cross sectional view of an over-voltage protection device according to a third embodiment of this invention and FIG. 15(b) shows a top view where the resin cover has been removed;

FIG. 16 shows a battery protection system according to a fourth embodiment of this invention;

FIG. 17 shows a cross sectional view of an angular type lithium ion battery;

FIG. 18 shows a diagrammatical view of an angular type lithium ion battery device for a device such as a portable telephone;

FIG. 19 shows a block diagram of a prior art protection circuit; and

FIG. 20 shows details of the prior art semiconductor protection circuit of FIG. 19.

### DETAILED DESCRIPTION OF THE PREFERRED EMBODIMENTS

The forms of the application of this invention will be explained in detail by referring to the attached drawings.

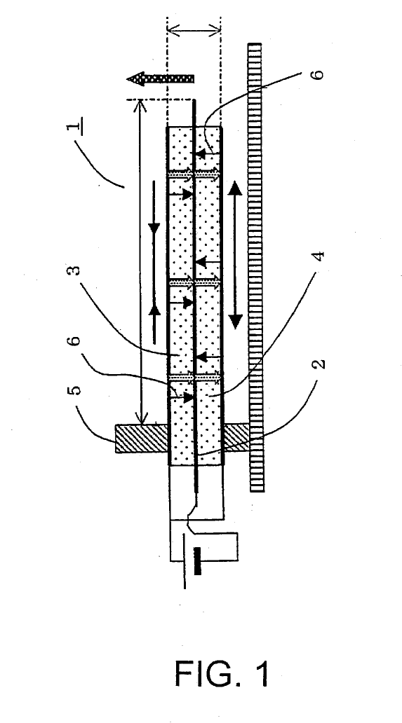

In accordance with this invention, a piezoelectric actuator is used preferably of a bimorph type. FIG. 1 shows in cross section a piezoelectric ceramic actuator 1. Piezoelectric actuator 1 has a shim plate 2 that runs inside in the longitudinal direction and piezoelectric elements 3 and 4 that are pasted to both sides of the shim plate 2. Shim plate 2 is a thin metal elastic sheet selected from among such materials as phosphorus bronze, beryllium copper, and stainless steel, to cite some examples, depending upon the specific application. Shim plate 2 can be used as an electric transmission moving piece for a relay, in which case a contact terminal is provided at the tip of the shim plate.

Piezoelectric elements 3 and 4 on both sides of the shim plate 2 are, for example, ceramic piezoelectric elements. Several kinds of materials have been developed and commercialized for these elements; however, a commonly used material is made from solid solution of PbZr03 and PbTi01. For the preparation of piezoelectric ceramics, a ceramic material which is in a pulverized state is heated, the grains are pulverized once again and a thin sheet which is called a green film is formed. The surface of this sheet is screen-printed with an electroconductive paste, thereby forming a surface electrode and then it is heated again at a high temperature. A direction current high voltage is impressed to the sheet for polarization treatment to be aligned in the direction of voluntary polarization. The piezoelectric ceramics 3 and 4 that have been given a polarization treatment are pasted on the shim plate 2 by a binder adhering in such a fashion that their polarization directions agree with each other.

Piezoelectric actuator 1 has its base part fixed by a member 5 to be supported in a cantilever style. Shim plate 2 gives mechanical strength to the piezoelectric actuator 1 and, at the same time, serves as a negative (or a positive) electric potential common electrode for the piezoelectric ceramics 3 and 4. A positive (or negative) electric potential is impressed to the surface electrodes of the piezoelectric ceramics 3 and 4. The surface electrodes of the two electrode elements 3 and 4 are short-circuited and are pulled out to the external terminals.

Next, the action of the piezoelectric actuator using the bimorph type piezoelectric ceramics will be explained.

For driving a bimorph actuator, a direct current voltage is impressed between the surface electrodes of the piezoelectric elements 3 and 4 and the shim plate 2. The same voltage is impressed between the piezoelectric elements 3 and 4 and the shim plate 2 on both surfaces by the parallel driving of the bimorph actuator. With piezoelectric actuators, there are those in which the electric boundary direction 6 is the same as the polarization direction of each piezoelectric element 3 or 4 and then there are others in which they are in opposition to each other. The piezoelectric elements in which electric boundary direction 6 and the polarization due to the reverse piezoelectric effect are in the same direction will contract in the longitudinal direction (refer to the piezoelectric element 3 in FIG. 1) where on the other hand, the piezoelectric elements in which the electric boundary direction 6 and the polarization are in opposite directions will elongate in the longitudinal direction (refer to the piezoelectric element 4 in FIG. 1). Because of this, the piezoelectric actuator 1 will move at its distal end or tip.

In the case where the piezoelectric actuator of the bimorph type described above which is cantilever mounted, is parallel-driven by the impressed voltage V, the amount of the displacement D at the tip and the force generated (force of displacement) F can be expressed by the following formula:

Amount of Displacement—D α K1×d₃₁×V×(L/T)²

Force Generated—F α K2×W×D×V

Where

K1 is a coefficient which is approximately six and K2 is a coefficient which is two,

D is the amount of the displacement,

d₃₁ is a piezoelectric coefficient in the width direction,

V is the impressed voltage,

L is the length of free vibrations,

T is the total thickness of the shim plate and the piezoelectric element, and

W is the width.

As is clear form the above formula, it becomes necessary to employ a material whose width-wise piezoelectric coefficient (d₃₁) is large in order to obtain a sufficient displacement D and the force F with a low voltage applied.

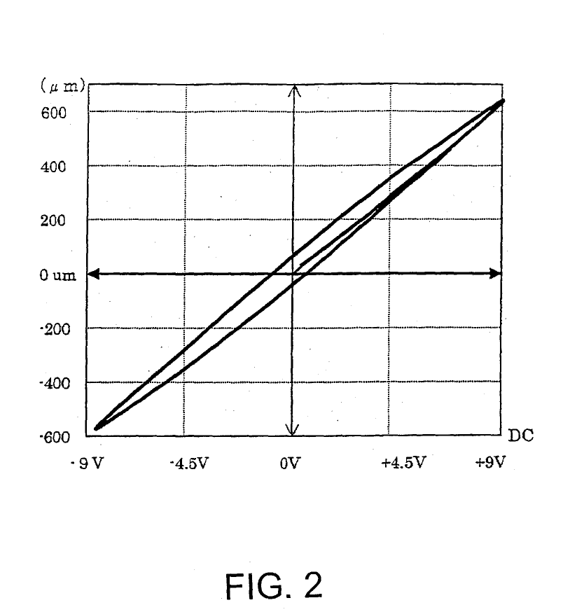

FIG. 2 shows the voltage-displacement characteristics in the case where the piezoelectric actuator was driven. In this experimental example, a displacement of approximately 220 microns was obtained by using a direct current voltage of 4.5 volts at the time when L=22 mm, T=120 (mu)m and W=four mm.

In the case where the piezoelectric actuator is used as the moving arm in a relay, there is need to design it taking into consideration the application requirements for the displacement of the actuator, the force generated, the structure, the contact current and the rated voltage, etc. In the event where the movement characteristics of the piezoelectric actuator are to be utilized, it needs to be remembered that the movement characteristics become different, depending upon the distance between the base part of the fixed actuator and the action point.

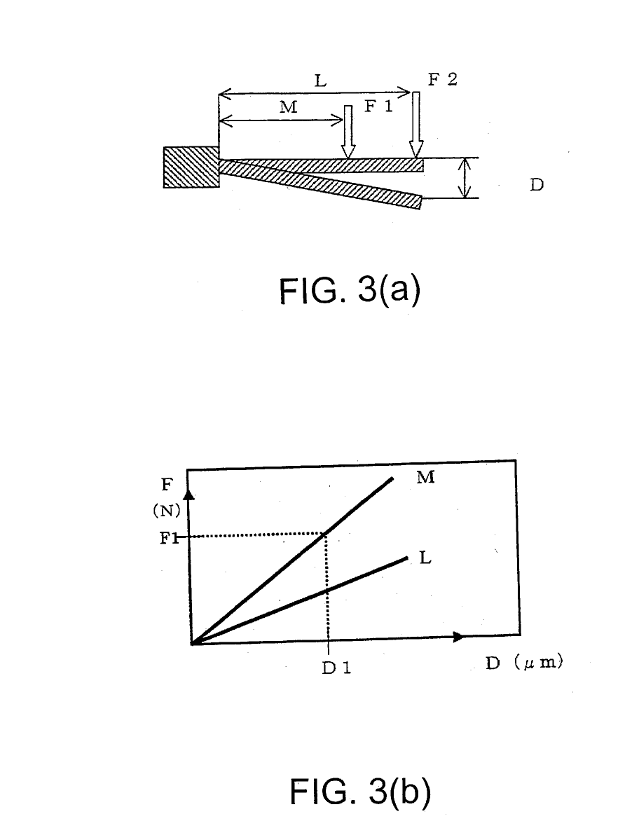

FIG. 3(a) shows the spring characteristics of piezoelectric actuator. FIG. 3(b) shows the relation between the displacement D and the force F. If the length (the length of free vibrations) of the piezoelectric actuator is set at L, when the tip has been displaced by D1, a force of F1 is generated at a point which is separated by a distance M. If a movable contact is set up in the piezoelectric actuator, it becomes possible to obtain a contact pressure of F1.

When the piezoelectric actuator is used in a relay application, it is desirable to increase the force to be generated. For example, it becomes possible to obtain a large displacement D and a force F by using multiple layers of extremely thin piezoelectric films.

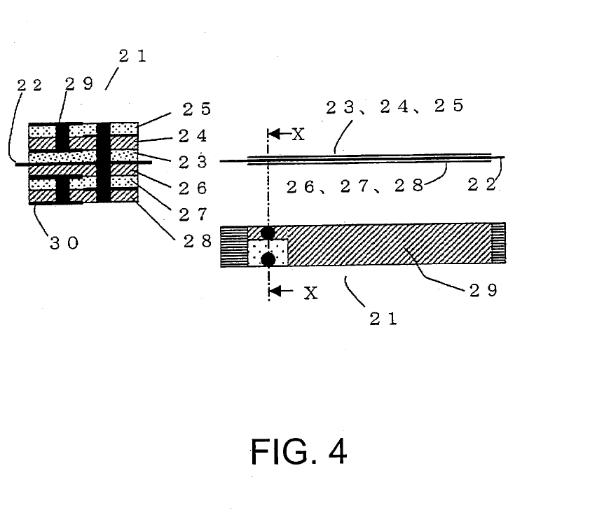

FIG. 4 shows a piezoelectric actuator which is prepared by laminating piezoelectric elements in three layers on each side of the shim plate for a total of six layers. The multi-layer piezoelectric actuator 21 has three layers of piezoelectric elements 23, 24 and 25 on one side and three layers of piezoelectric elements 26, 27 and 28 on the other side of the shim plate 22. The six layers of piezoelectric elements are arranged in such a fashion that, for each layer, the polarized directions may be alternately different. The electrodes that exist on the boundary surface between the piezoelectric elements 23 and 26, on the boundary surface between 24 and 25 and the boundary surface between 27 and 28 are short-circuited and, as they are connected to the shim plate 22, one side of the electric potential is supplied.

The surface electrode 29 of the piezoelectric element 25 is short-circuited with the electrode that exists on the boundary surface between the piezoelectric elements 23 and 24 and the surface electrode 30 of the piezoelectric element 28 is short-circuited with the electrode that exists on the boundary surface between the piezoelectric elements 26 and 27, with the other electric potential being supplied to the surface electrodes 29 and 30, thereby making the impressed voltages on the layers equal to each other. In this case, the amount of the displacement D becomes smaller in inverse proportion to the thickness as a whole; however, the force F generated becomes larger in proportion to the width and the thickness.

By adopting a piezoelectric element having a multi-layer laminated structure as an actuator of the bimorph type and using low-voltage driving, it becomes possible to obtain a large force and a large displacement which are necessary for the relay action. When a large force generated is obtained, it also becomes possible to provide for a displacement amplification. By controlling the thickness of each piezoelectric element, the thickness of the shim material, the thickness of the whole, the free vibration length and the width, as the parameters, an optimum actuator can be made.

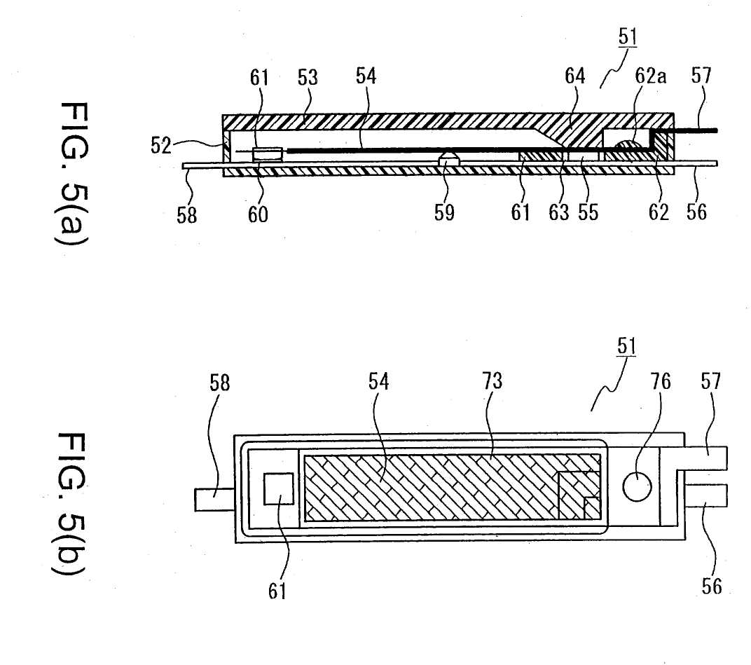

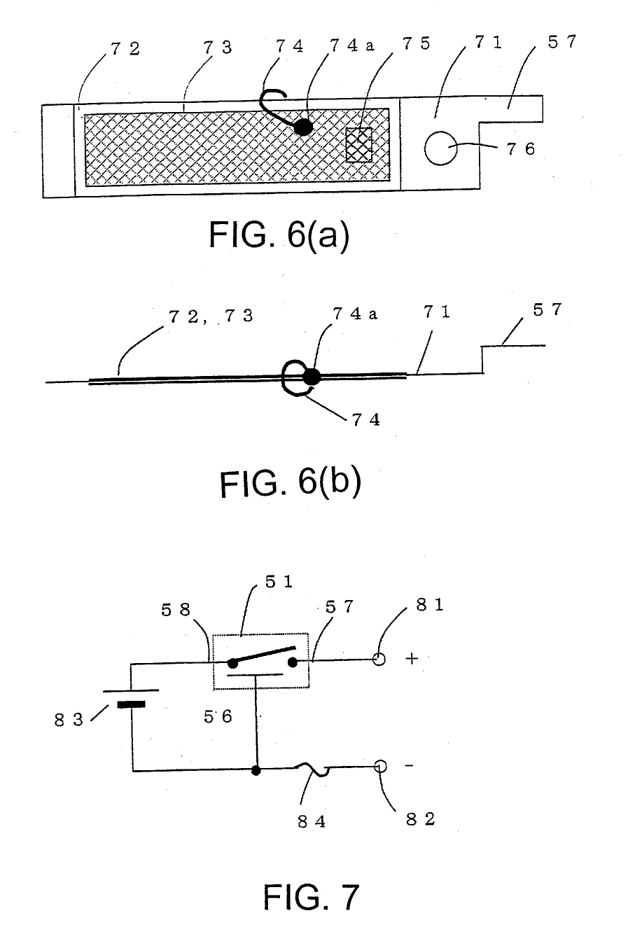

FIGS. 5(a) and 5(b) show the construction of an over-voltage protection device 51 according to the first embodiment of this invention. Over-voltage protection device 51 has an insulated main resin casing 52 in the shape of a rectangular parallelepiped with one side being open and an electrically insulative resin cover 53 whose purpose it is to seal the open surface and provide a closed space inside. Casing 52 and cover 53 are secured by any conventional means such as supersonic wave welding. The main casing 52 accommodates a piezoelectric actuator 54 preferably of the bimorph type to be driven at low voltage, an electroconductive connector 55, and external terminals 56, 57 and 58.

The external terminals 56 and 58 are integrally molded with the main casing 52 with one end of the external terminals 56 and 58 each protruding from opposite ends of the main casing body 52. The other end of the external terminals 56 and 58 each extends in the main casing body 52 and stop at an insulating protrusion 59 that has been provided approximately at the center of the device. A stationary contact 60 of an electrically conductive metal material is provided on the external terminal 58. A movable contact 61 made of an electrically conductive metal material is provided at one end of piezoelectric actuator 54. Movable contact 61 is positioned on actuator 54 so as to be able to contact stationary contact 60. The other end of the piezoelectric actuator 54 is connected to the external terminal 57 by its shim plate (as explained below) and the piezoelectric ceramic electrodes that have been provided on both sides of the shim plate are connected to external terminal 56 through an electroconductive connector 55.

At the bottom of the main casing body 52, a space 63 is formed by means of the resin blocks 61 and 62 for receiving and positioning electroconductive connector 55. It is desirable to use an elastic electroconductive connector such as one prepared by mixing an electroconductive metal with silicon rubber. As an alternative, for example, a spring-shaped metal connector may also be used.

On the reverse bottom side of the resin cover 53, a protuberant part 64 having a flat top surface is formed preferably integrally with resin cover 53. Protuberant part 64 is positioned above space 63 and the top surface of the protuberant part 64 presses against electroconductive connector 55 through the piezoelectric actuator 54. The surface electrode of the piezoelectric ceramics is electrically connected to the external terminal 56 through the electroconductive connector 55. At the time when the resin cover 53 has been fixed to the main casing body 52, the center portion of the piezoelectric actuator 54 rests against a protrusion 59 and movable contact 61 is in firm engagement with stationary contact 60.

The over-voltage protection device in this embodiment has a triple-terminal structure, where a metal plate 71 which is called a shim plate acts as a substrate for piezoelectric actuator 54 and is electrically connected to the external terminal 57. Shim plate 71 may be formed integrally with the external terminal 57 or it may be welded to the terminal. Shim plate 71 functions as a relay movable arm of the piezoelectric actuator and, at the same time, transmits the electric current that has been supplied from the external terminal 57 to the stationary contact 60 through a movable contact 61.

In preparing the piezoelectric actuator 54 in this example of the invention, the piezoelectric ceramics 72 has a multi-layer structure having six to ten layers. The overall thickness including the shim plate 71 was less than several hundred microns, and care was exercised that its length would be in a range between 20 and 30 mm and its width in a range between approximately three to 10 mm. By having this multi-layer structure, it is possible to produce a generating force which is required for an effective actuator even when it may operate under a comparatively low voltage.

Multi-layer piezoelectric ceramics 72 are adhered on both sides of the shim plate 71 and an electrode layer 73 is formed on the surface of the piezoelectric ceramics. The electrode layers 73 on the top and bottom surfaces of piezoelectric ceramics 72 are short-circuited by means of a wire 74 that links the upper and lower electrode layers. Otherwise, the electrode layers 73 may be short-circuited by means of a conductor 74a that fills a hole that runs through the piezoelectric ceramics 72 and shim plate 71 with electrically conductive material.

The electrodes of the inner piezoelectric ceramics are short-circuited in the same manner as explained in connection with FIG. 4. Each electrode layer 73 is coated with a moisture-preventive film that prevents the electrode layer from being exposed and an opening 75 is formed on said film in such a manner to allow its contact with electroconductive connector 55.

In addition, a hole 76 is formed at the base of the shim plate 71 and, at the time when the piezoelectric actuator 54 is arranged inside the main casing body 52, the hole 76 is potted by a resin 62a on the resin block 62, thereby positioning and fixing the piezoelectric actuator within casing 52.

The operation of the over-voltage protection device 51 is carried out by impressing voltage between the external terminals 56 and 57. When voltage is impressed between these two terminals, the bimorph piezoelectric actuator 54 can be varied either upward or downward, depending upon the polarization direction and the direction of the electric field impressed in each layer of the piezoelectric ceramics.

In this embodiment, the movable contact 61 of the piezoelectric actuator 54 is initially in contact with stationary contact 60; however, if the voltage between the external terminals 56 and 57 becomes higher than a prescribed voltage, the piezoelectric actuator 54 is displaced upward, and accordingly, movable contact 61 becomes disengaged from the stationary contact 60. The use of protrusion 59 as a fulcrum allows the piezoelectric actuator 54 to displace movable contact 61 rather abruptly.

In accordance with this invention with its three terminal design, the over-voltage protecting device 51 can be easily mounted and the number of its parts is small, which allows it to be produced in a small size at a low cost.

Even though the over-voltage protecting device has been described with a resin casing, it could also be made with a water proof metal casing which would have high reliability against the possible leak of the electrolyte from the battery.

In the above-described embodiment, moreover, a shim plate was used in the piezoelectric actuator so as to increase its mechanical strength. In the absence of such necessity, however, the shim plate may be eliminated.

FIG. 7 shows the use of a over-voltage protecting device according to this invention used in the protective circuit. The external terminal 57 of over-voltage protection device 51 is connected to a positive-pole terminal 81 to which the charging device is connected. The external terminal 58 is connected to the positive electrode of a lithium ion battery 83 and the external terminal 56 is electrically connected to the negative pole terminal 82 through temperature fuse 84.

During charging, the charge voltage current flows from the positive pole terminal 81 and the positive pole of the battery through the actuator and relay contacts and is returned to the charger from the negative pole terminal 82 through the negative pole of the battery. At the time of a discharge, the electric current flows in the opposite direction.

Upon an abnormal operation of the charging device, lightning, electrostatic discharges, etc., if a surge voltage appears between the terminals 81 and 82, an over-voltage is impressed to the piezoelectric actuator through the external terminals 56 and 58 thereby causing the piezoelectric actuator to be displaced and the current passageway between the terminals 57 and 58 to be shut off.

The piezoelectric actuator is tripped within a period of several micro-seconds, thereby opening the circuit. During the time when the detected voltage between the external terminals 56 and 57 is maintained above the operating voltage, the open state is continued by means of the actuator relay keeping the contacts open. When the voltage impressed between the external terminals 56 and 58 comes down, the relay will close the contact once again, thereby making it possible to charge or discharge the lithium ion battery 83. This operating voltage is set either at the permissible maximum voltage Vp as recommended by the battery manufacturers or at a level which is slightly higher than that. Generally speaking, the permissible maximum voltage value for the protection of over-voltage impression to the battery is approximately 4.3 volts.

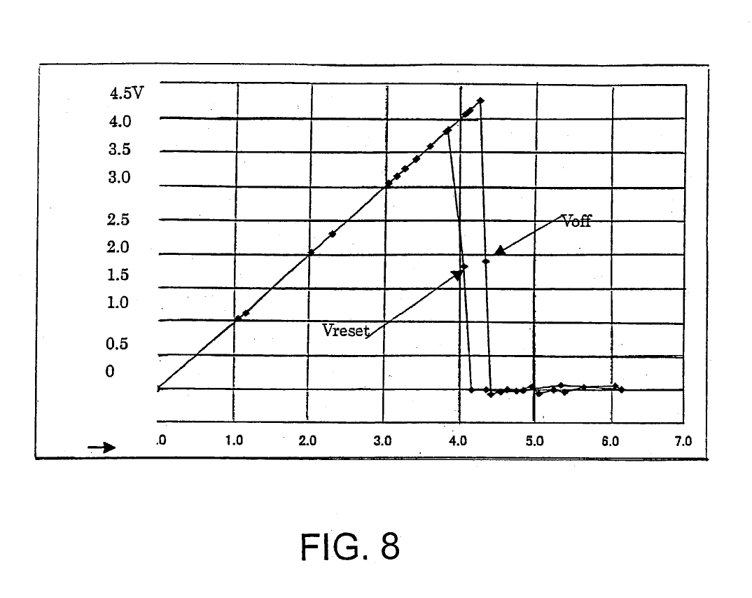

FIG. 8 shows the circuit shut-off action characteristics of an over-voltage protecting device of this invention. The output voltage (the voltage between the terminals 81 and 82) as measured at the time when the voltage inputted to the over-voltage protecting device 51 (the lithium ion battery 83 in FIG. 7 is given variable input voltage) has been modified as shown.

At the time when the input voltage is rising, the movable contact is tripped at Voff, with a result that the circuit is shut off. In the case where the voltage is lowered slowly from the high voltage side, the movable contact that was opened at Vreset is again closed. This voltage differential is the hysteresis voltage Vhys. This hysteresis prevents the ripple of the contact of the over-voltage protecting device and prevents the action of the movable contact to be once again restored.

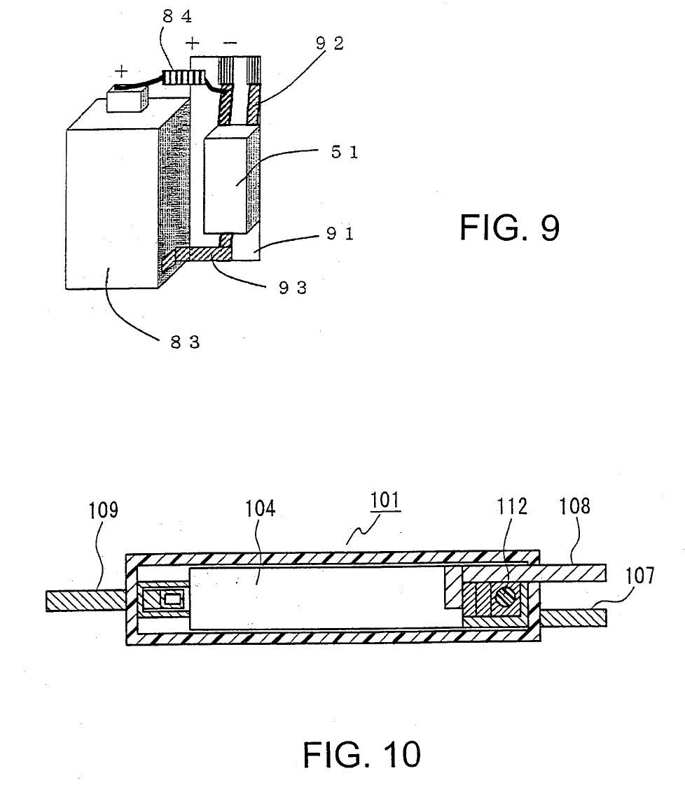

FIG. 9 shows an embodiment where the over-voltage protecting device has been mounted on a lithium ion battery.

The over-voltage protecting device 51 is fixed onto a support member 91 and the external terminals are connected to the electrode terminals of the lithium ion battery 83 through the connective tabs 92 and 93. The casing or housing for the over-voltage protecting device 51 is preferably a sealed device to protect against damage from leaking electrolyte, etc. Either a resin casing or a metal casing can be used as this casing. When a metal casing is used, it may be better if the desired part is covered with an insulating seal. It would be desirable to have the over-voltage protection device 51 and the battery 83 in close proximity to one another so as to make it possible for the temperature fuse 84 to suitably sense the temperature of the battery.

The piezoelectric actuator that is employed in the over-voltage protecting device of the present invention preferably has a capacity of several thousand pico-farads and is voltage-driven. Also, its power consumption at the time of a slow voltage variation such as when the battery voltage is extremely small is near zero. That is, it scarcely consumes electric power except when actively operational. Moreover, it has an advantage that its noise resistance is high.

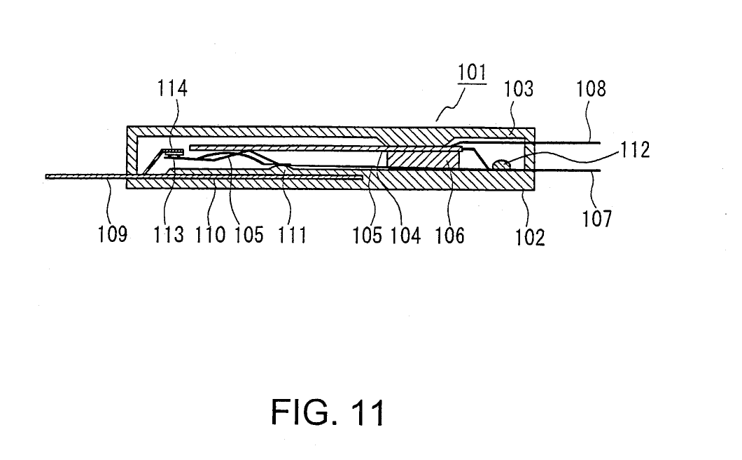

A second embodiment of this invention is shown in FIGS. 10 and 11. The over-voltage protection device 101 according to this embodiment provides a snap relay action by converting the linear displacement action of the piezoelectric actuator into a snap action, thereby realizing sharp shut-off characteristics.

This snap action of the relay mechanism is accomplished by the use of a spring member in conjunction with a piezoelectric actuator 104. Spring member 105 is constructed to be capable of snap action. An over-voltage protective device 101 comprises a main casing body 102 and a resin cover 103. In the space that is formed by joining together of the members, there is provided a piezoelectric actuator 104, spring member 105, a resin block 106 and terminals 107, 108 and 109.

The piezoelectric actuator 104 is cantilever mounted in device 101 with its base part being supported by a resin block 106 which is arranged between resin cover 103 and main casing body 102, with its tip end portion movable in response to the voltage that is impressed between the terminals 107 and 108. An end portion 110 of terminal 109 extends into and is contained in casing body 102 and said end portion 110 is supported in the bottom wall of the main casing body 102.

On the surface of the bottom wall of casing body 102, a protrusion 111 is formed with spring member 105 being is positioned to rest on protrusion 111 generally adjacent the tip end portion of spring member 105. The other end of spring member 105 is fixed between the main casing body 102 and the resin block 106 with its distal portion extending further within body 102 to make electrical connection to external terminal 107. External terminal 107 is also electrically connected to piezoelectric actuator 104 (typically the shim plate) and the end of the other end spring member 105 and the end of the shim plate are fixed together and to main casing body 102 by means of staking member 112 of resin material.

A movable contact 113 is provided at the tip end portion of spring member 105 and is positioned to be in engagement with a stationary contact 114 that is fixed to an extension of external terminal 109. As mentioned above, the middle part of the spring member 105 is supported by a protrusion 111 and movable contact 113 is in engagement with stationary contact 114 under a certain fixed pressure. The tip end portion of the piezoelectric actuator 104 is positioned in contact with the spring member 104. External terminal 108 is electrically connected to the surface electrode portion of the piezoelectric actuator 104.

At the time of a normal operation, the electric current that has been supplied to external terminal 107 flows through the plate member 105 to external terminal 109 through the movable contact 113 and stationary contact 114. When the impressed voltage between the external terminals 107 and 108 exceeds a predetermined voltage value, the tip of the piezoelectric actuator 104 exerts a downward displacement force on spring member 105 and, if the displacement force becomes large enough, it overcomes the turn-over snap force of the spring member 105 to snap over center which results in the rapid separation of movable contact 113 from stationary contact 114. The circuit path through device 101 is now open.

The over-voltage protection device of this embodiment does not use the piezoelectric actuator 104 as a current carrying member for device 104 but rather uses it as an independent actuator. Accordingly, such a device allows for a use for a wide range of electric current ratings. Moreover, the snap action feature by using spring member 105 results in quick, precise circuit shut-off action, thereby preventing the so-called “creep phenomenon” in which the opening and closing action of the switch is carried out slowly.

The setting or calibration of an opening action value of the contacts of over-voltage protecting device 101 can also be easily made through an adjustment of the mechanical position of the contacts. For example, the testing of the opening action voltage can be carried out by moving the terminal positions and/or by mechanically deforming the brass terminal on which the stationary contact is installed.

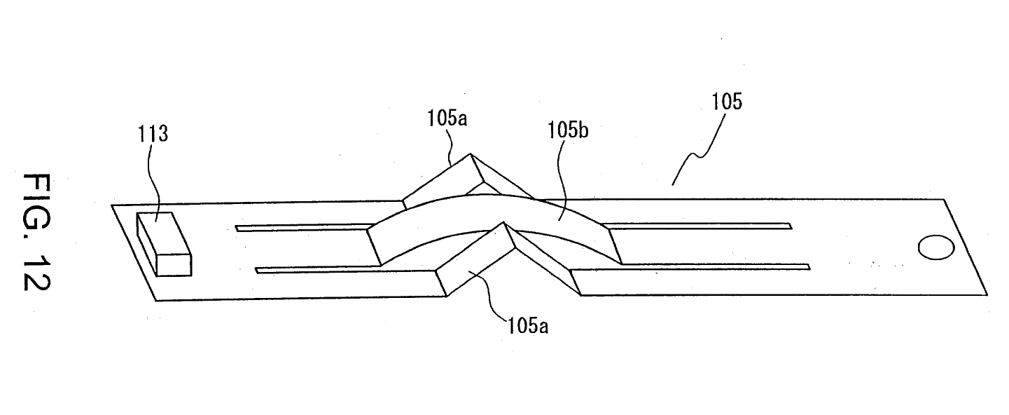

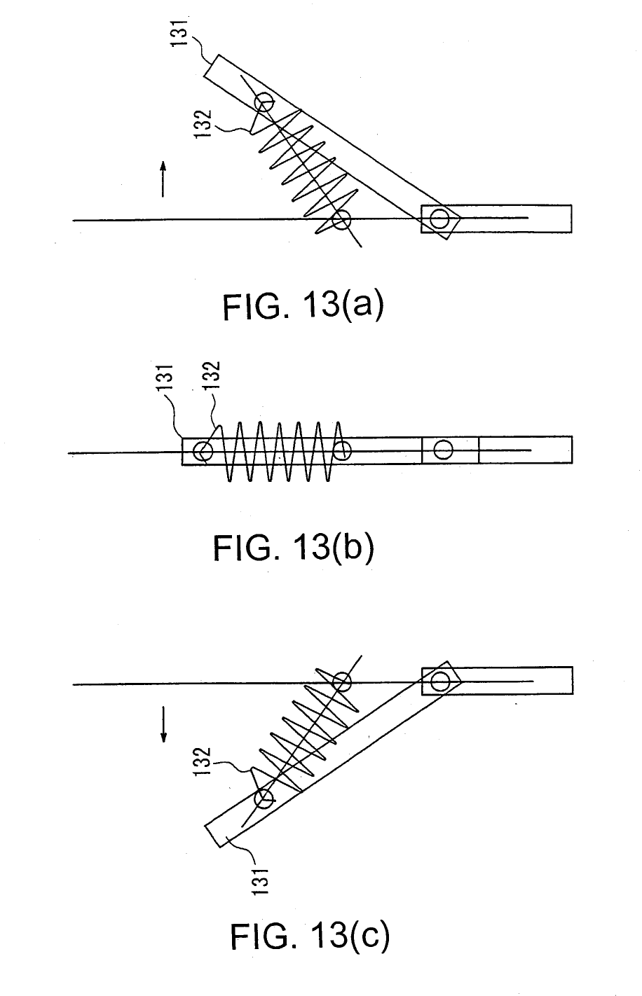

FIG. 12 shows a spring member which can be used for the snap action. Plate spring 105 functions as a movable arm which also carries electric current. A typical material for spring member 105 would be phosphorus bronze, beryllium copper, stainless steel or the like, in the form of a thin metal sheet. Two narrow parallel grooves are punched in the sheet part and the edge portion of the sheet adjacent the grooves are plastically deformed yielding two raised angled ribs 105a with a central rounded rib 105b. This construction provides the snap acting characteristics for the spring member and is shown in FIG. 13 and explained below.

The main body of the spring member 105 is expressed by an arm 131 and the spring parts (raised angled ribs and central rounded rib) 105a and 105b are expressed diagrammatically as spring 132. In FIG. 13(a), the tip (movable contact) of the spring member is in a state where it is biased toward the left side, FIG. 13(b), the tip is in a neutral state, and in FIG. 13(c), the tip is in a state where it is biased to the right-side.

The spring member or arm 131 is not in a stable state at the neutral point shown in FIG. 13(b) but it attempts to get into the state shown in (13(a) or 13(c) due to the action of the spring 132. Because of this fact, when a force which is necessary for a displacement from (a) to (b) is applied from outside, the spring member will displace instantly into the state shown in FIG. 13c by the snap action. The opposite is also true.

The spring member 105 is initially biased so that the movable contact 113 at its tip is firmly in contact with the stationary contact 114. As the tip of the spring is pressed in a direction to move the contacts apart, it snaps to one side due to the force of the spring at the time when the tip has entered slightly into the opposite side. This is called a snap action, and is often used in such a protective element as the bimetal, etc.

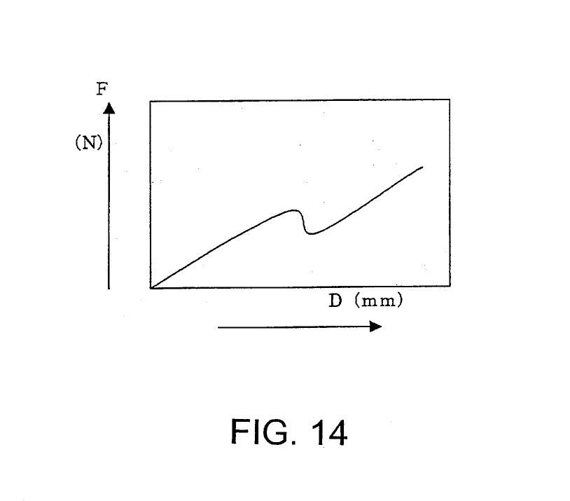

The relation between the displacement and the stress at the time of a snap action is shown in FIG. 14. As is shown in this figure, an S-shaped curve is drawn at the time of a displacement.

The construction of a spring member as shown in FIG. 12 is used by way of example. It is possible to carry out the snap action by using other metal plates of various shapes made of various kinds of materials. Even though an over-voltage protecting device of the triple-terminal structure has been used in the above example, it is also possible to use a four-terminal structure in which the two terminals for relay and the two voltage detection drive terminals are used independently. In such a case, the mechanism will be the same as the ordinary relay mechanism, making it possible to effect a relay action with a small power at low voltage and also making it possible to be used under a wide range of conditions.

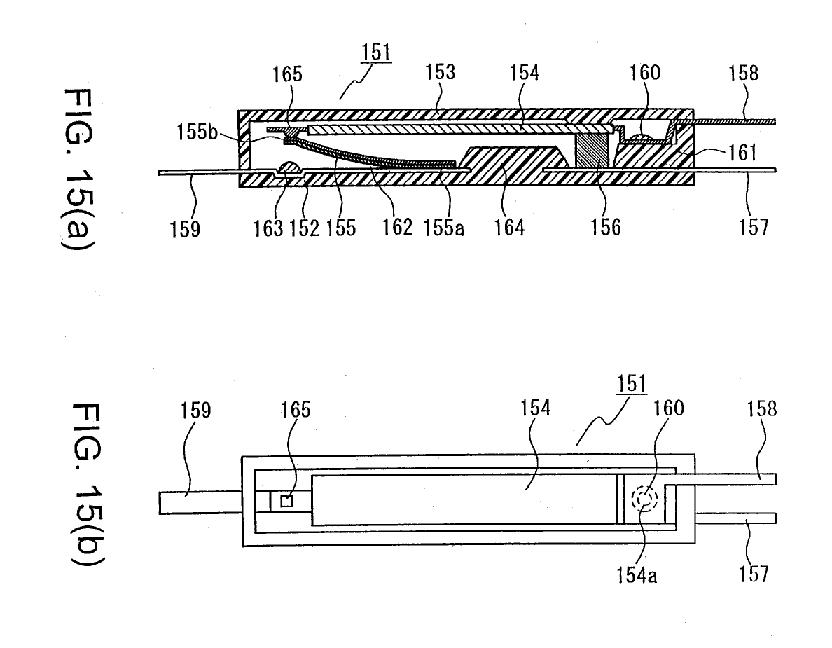

FIG. 15 shows an over-voltage protecting device according to a third embodiment of this invention. An over-voltage protecting device 151 further includes a thermally responsive bimetal element 162 in addition to the protective function against over-voltage and the protection function against over-current and abnormal temperature.

The protective device 151 includes a main casing body 152 and a resin cover 153 providing for an internal enclosed space. This enclosed space contains a piezoelectric actuator 154, a bimetal element 155, an electroconductive connector 156 and external terminals 157, 158 and 159.

The piezoelectric actuator 154 is fixed at one end on a securing stand 161 formed in the main casing body 152 by use of an attachment member 160 such as resin potting material and a hole 154a. The base part of the piezoelectric actuator 154 is electrically connected to external terminal 157 through an electroconductive connector 156. The piezoelectric actuator 154 is supported on electroconductive connector 156 using it as a fulcrum.

The external terminal 159 has an extension part 162 which extends into internal enclosed space from the main casing body 152 inwardly, with a stationary contact 163 being attached to it in the vicinity of its center.

The end of the extension part 162 is fixed inside a block 164 generally at the center of the main casing body 152. Additionally, an end 155a of bimetal element 155 is soldered to extension part 162 adjacent its end. The other end 155b of the bimetal element 155 is positioned to be in direct contact at a prescribed contact pressure with a movable contact 165 that has been attached to the tip of the piezoelectric actuator 154. The end part of external terminal 157 that extends into the main casing body 152 is also fixed inside block 164.

During ordinary operation, the electric current that is supplied to the external terminal 158 is transmitted from the piezoelectric actuator 154 through the movable contact 165, the bimetal element 155 and the extension part 162. When over-voltage is impressed between the external terminals 157 and 158, the bimorph piezoelectric actuator is displaced and, when the displacement force of the movable contact 165 at its tip exceeds the snap action pressure of the bimetal element 155, the bimetal element 155 snaps and the other end 155b of the bimetal 155 contacts the fixed contact 163, with a result that the current path is opened.

At this time, a fixed distance is maintained between the movable contact 165 and the other end 155b of the bimetal element due to the fact that the displacement of the tip of actuator 154 is significantly less than the travel distance of the snap action of bimetal element 155.

In the case where over-voltage is not impressed between the external terminals 157 and 158, but the lithium ion battery generates heat due to some trouble and/or the ambient temperature is high so as to cause the temperature of the bimetal element to exceed the predetermined snap temperature of the bimetal element, the bimetal element 155 will snap over center and the end 155b of the bimetal 155 will move from engagement with movable contact 165 to engagement with stationary contact 163, thereby shutting off current flow.

In the case where an abnormal current flows due to over-charging, over discharge, electrostatic discharge or short-circuiting, etc., the bimetal element 155 will actuate (snap) due to the self-generated heat which will shut off the current flow. Accordingly, the over-voltage protecting device according to this embodiment is capable of not only providing over-voltage protection but also protection against over-current and abnormal high temperature conditions. By means of a single protection device, it can offer the primary and numerous other protective functions.

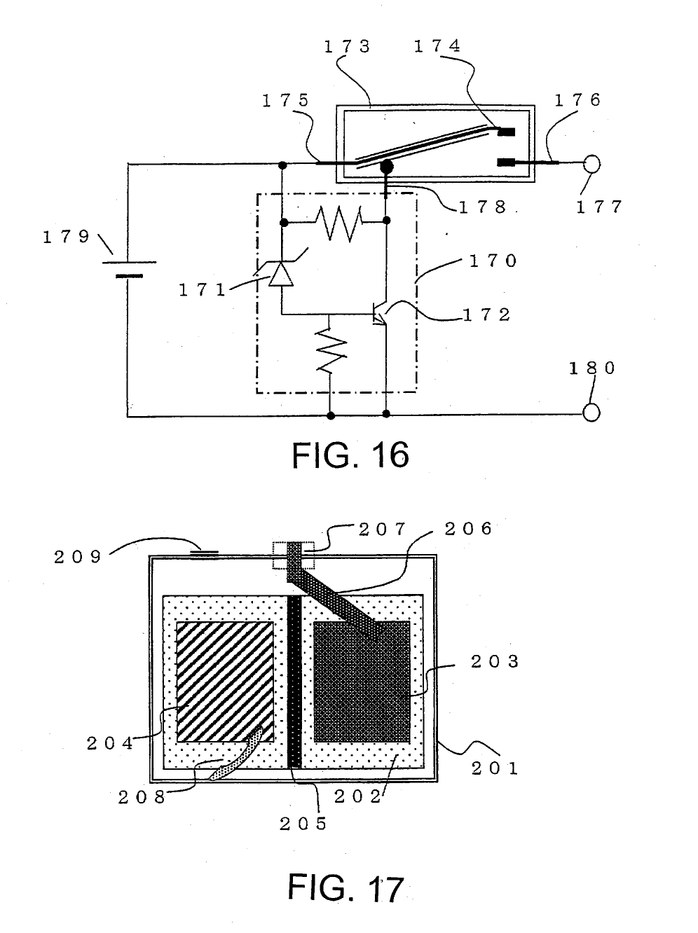

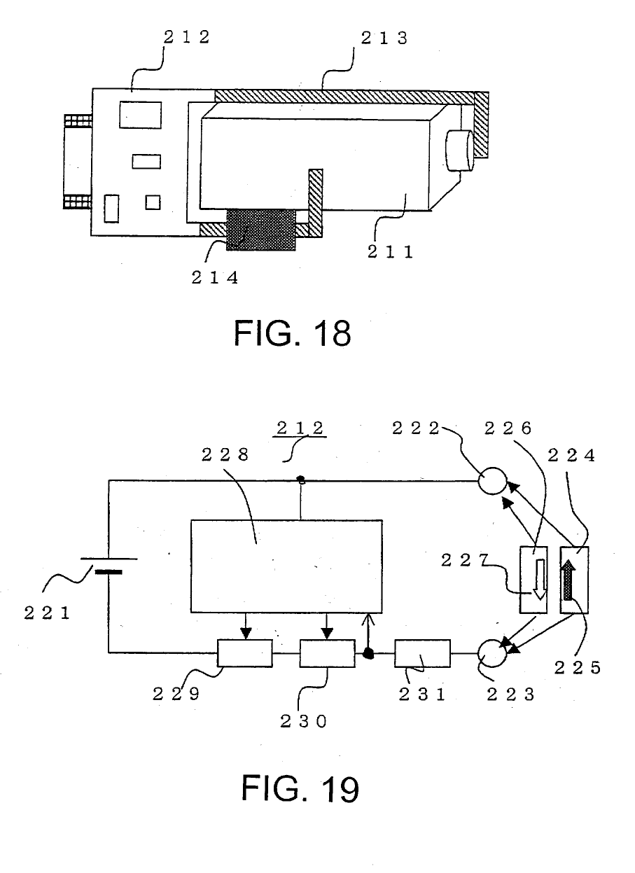

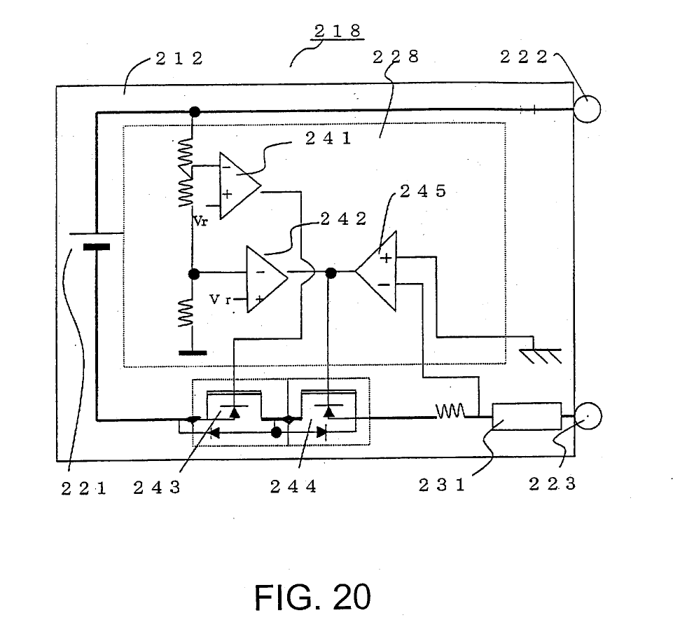

Next, a forth embodiment of this invention will be explained by referring to FIG. 16. In this embodiment, a snap action drive circuit based on a semiconductor element is provided in the protective circuit using the over-voltage protection device of this invention. By using this circuit, an electronic snap action is realized.

In this drawing, a snap action drive circuit 170 reduces the erroneous voltage of the contact opening action voltage by using a fixed voltage zener diode 171 and the NPN bipolar transistor 172. The cathode of the zener diode 171 is connected to the relay terminal 175 of the piezoelectric actuator 174 of the over-voltage protecting device 173 and the other relay terminal 176 is connected to the positive electrode terminal 177.

The anode of the zener diode 171 is connected to the base of the NPN transistor 172 and a resistance is connected between the base and the emitter. The collector of the NPN transistor 172 is connected to the voltage detection terminal 178 of the over-voltage protecting device 173 and, at the same time, is connected to the cathode of the zener diode 171 through a resistance, and the emitter is connected to the battery 179 and the negative electrode terminal 180.

With the voltage of the fixed voltage diode 171 being expressed by Vz, when the charge voltage becomes Vz+Vbe (voltage between the base and the emitter being approximately 0.5 volts), the fixed voltage diode 171 is made electrically conductive and the current starts flowing, thereby setting the NPN transistor 172 on. The collector voltage drops because of the collector Ic and the voltage Vce between the base and the emitter becomes less than 0.1 volt. As a consequence of this, the potential difference between the relay terminal 175 and the voltage detection terminal 178 becomes higher than the voltage value at which the piezoelectric actuator 174 operates and the movable contact is tripped from the stationary contact, thereby opening the circuit. At the time of the snap action drive, there is some consumption of the power by the NPN transistor 172. When the excess voltage of the battery 179 is lowered below the protective voltage, the snap action drive circuit 170 is once again brought into the off state, without the flow of the current, thereby making the power during the waiting period zero.

In accordance with the invention, the over-voltage protecting device operates only by means of piezoelectric passive elements, thereby making it possible to reduce the number of parts of the protection device and simplify same, resulting in a low cost device.

If such an over-voltage protecting device is used for the secondary batteries, the secondary batteries themselves can be made extremely small in size, with a corresponding reduction in the manufacturing cost, thereby making them suitable for use in such devices requiring a reduction in size as the portable telephones, etc.

If the piezoelectric actuator is accommodated in a sealed casing, moreover, there is no fear that leaking electrolyte from the battery will effect the operation of the over-voltage protection device.

Various embodiments of this invention have been explained above. It is not intended however that the invention be restricted to these embodiments. Moreover, the embodiments shown above can be modified in various ways within the range of this invention.

What is claimed:

1. An overload voltage protection device for protecting a secondary battery comprising a casing, at least first, second and third terminals, and a piezoelectric actuator having first and second electrodes, the piezoelectric actuator being cantilever supported in the casing with a movable contact being mounted at the distal end of the actuator positioned to be able to make and break contact with a stationary contact on said third terminal, the first and second electrodes of the piezoelectric actuator being electrically connected to the first and second terminals respectively, whereby when a voltage above a predetermined level is impressed between the first and second terminals, the distal end of the piezoelectric actuator is capable of being displaced thereby bringing the movable contact out of or into engagement with the stationary contact.

2. An overload voltage protection device as set forth in claim 1 wherein said piezoelectric actuator contains piezoelectric ceramic elements of the bimorph type.

3. An overload voltage protection device as set forth in claim 2 wherein said piezoelectric actuator contains a metal plate that extends at its center in the longitudinal direction and a plurality of piezoelectric elements which are laminated on both sides of the metal plate, said metal plate functions as the first electrode for the actuator.

4. An over-voltage protection device as set forth in claim 1 wherein said casing substantially encloses the protection device with said first and second terminals protruding from a first end of the casing in a longitudinal direction and said third terminal protruding from a second end that opposes said first end of said casing.

5. An over-voltage protection device as set forth in claim 1 wherein said secondary battery is chosen from the group consisting of lithium ion batteries and lithium polymer batteries.

6. An over-voltage protection device for protecting a secondary battery comprising a casing, at least first, second and third terminals at least partially contained in said casing, said third terminal having a fixed electrical contact mounted thereon, a piezoelectric actuator cantilever mounted in said casing, having first and second electrodes, and a movable electrically conductive member contained in said casing, having a movable electrical contact mounted thereon, said movable contact being positioned to be able to make and break contact with said fixed contact in response to movement by said piezoelectric actuator, said first and second electrodes of the piezoelectric actuator being electrically connected to the first and second terminals respectively, whereby, when a voltage above a predetermined level is impressed to the first and second terminals, the piezoelectric actuator is capable of movement to thereby cause said movable member to move so that the movable contact will move out of or into engagement with the stationary contact.

7. An over-voltage protection device of claim 6 wherein said movement member is a snap action member.

8. An over-voltage protection device of claim 7 wherein said snap action member is a thin metal plate with a deformed spring part to provide the snap action.

9. An over-voltage protection device comprising a casing, at least first, second and third terminals, a piezoelectric actuator and a snap acting bimetal element contained in said casing, said piezoelectric actuator having first and second electrodes electrically connected to said first and second terminals respectively, said bimetal element being positioned between said piezoelectric actuator and said third terminal, a first end of the bimetal member being fixed to said third terminal and a second end being in engagement with said piezoelectric actuator, said piezoelectric actuator cantilever mounted in said casing with its distal end capable of being displaced in response to a voltage above a predetermined level being impressed between the first and second terminals so as to be able to cause the second end of said bimetal element to snap out of engagement with the piezoelectric actuator, said snap acting bimetal element also being capable of snapping out of engagement with said piezoelectric actuator upon over-temperature and over-current conditions.

10. An over-voltage protection device of claim 9 wherein said first terminal, said piezoelectric actuator, said bimetal element and said third terminal form a current pathway through the device with the snap action of the bimetal element causing a break in the current pathway.

11. A battery protection system for a secondary battery using the over-voltage protection device according to claim 1.

12. A battery protection system for a secondary battery using the over-voltage protection device according to claim 6.
